(19) United States
(12) Patent Application Publication
(10) Pub. No.: US 2021/0239011 A1
(43) Pub. Date: Aug. 5, 2021

(54) AXIAL FLOW TURBINE

(71) Applicant: TOSHIBA ENERGY SYSTEMS & SOLUTIONS CORPORATION, Kawasaki-shi (JP)

(72) Inventors: Yuichi MORISAWA, Yokohama Kanagawa (JP); Shogo IWAI, Ota Tokyo (JP); Hideyuki MAEDA, Yokohama Kanagawa (JP); Asako INOMATA, Yokohama Kanagawa (JP); Kazutaka TSURUTA, Yokohama Kanagawa (JP)

(73) Assignee: TOSHIBA ENERGY SYSTEMS & SOLUTIONS CORPORATION, Kawasaki-shi (JP)

(21) Appl. No.: 17/165,141

(22) Filed: Feb. 2, 2021

(30) Foreign Application Priority Data
Feb. 4, 2020 (JP) 2020-017447

(51) Int. Cl. F01D 25/12; F01D 25/24

(52) U.S. Cl. CPC F01D 25/12; F01D 11/001; F01D 25/24

(57) ABSTRACT

An axial flow turbine of an embodiment includes: a turbine rotor provided to penetrate in an inner casing; rotor wheels formed on an outer peripheral surface of the turbine rotor in an axial direction; a gland seal part which is provided on a downstream side of the rotor wheel at a final stage and seals between the turbine rotor and the inner casing; a seal part which is provided between the rotor wheel at the final stage and the gland seal part and prevents inflow to the turbine rotor side of a working fluid; and a cooling medium supply mechanism which supplies a cooling medium directly to a wheel space surrounded by the rotor wheel at the final stage, the turbine rotor, the gland seal part and the seal part.

### CROSS REFERENCE TO RELATED APPLICATIONS

This application is based upon and claims the benefit of priority from Japanese Patent Application No. 2020-017447, filed on Feb. 4, 2020; the entire contents of which are incorporated herein by reference.

### FIELD

Embodiments described herein relate generally to an axial flow turbine.

### BACKGROUND

In power generation plant, as a power source for power generation, an axial flow turbine such as a gas turbine or a steam turbine has been utilized.

In such an axial flow turbine, in order to improve turbine performance, an increase in temperature at the entrance of the turbine has been achieved. This sometimes causes a temperature of a working fluid to become equal to or more than heat-resistant temperatures of turbine members constituting a rotor blade, a stator blade, a turbine rotor, and the like.

Therefore, such an axial flow turbine includes a structure in which the turbine members are cooled by a cooling medium. For example, as one example of a cooling structure, a structure in which the cooling medium is introduced to the inside of the rotor blade or the stator blade, a structure in which the cooling medium is introduced to the inside or on an outer peripheral surface of the turbine rotor, and the like have been employed.

FIG. 11 is a view illustrating a meridian cross section of a conventional axial flow turbine 300. FIG. 11 illustrates a cross section including downstream-side turbine stages and an exhaust hood. Further, FIG. 11 illustrates a turbine structure of a gas turbine.

As illustrated in FIG. 11, the conventional axial flow turbine 300 includes an outer casing 310 and an inner casing 311 inside the outer casing 310. Further, a turbine rotor 340 is provided to penetrate the inner casing 311 and the outer casing 310.

An outer shroud 320 is provided on an inner periphery of the inner casing 311 over a circumferential direction. An inner shroud 321 is provided inside the outer shroud 320 over the circumferential direction. Then, between the outer shrouds 320 and the inner shrouds 321, a plurality of stator blades 322 are supported in the circumferential direction to constitute a stator blade cascade.

Here, the circumferential direction is a circumferential direction around a center axis O of the turbine rotor, that is, around an axis of the center axis O.

Inside the inner shroud 321, a heat shield piece 325 is provided over the circumferential direction opposite to the inner shroud 321. A sealing portion 326 is formed between the inner shroud 321 and the heat shield piece 325. Further, the heat shield piece 325 is implanted in the turbine rotor 340.

The turbine rotor 340 includes a rotor wheel 341 projecting to the radial outside over the circumferential direction. The rotor wheel 341 is provided in a plurality of stages in a center axis direction of the turbine rotor 340. Then, a plurality of rotor blades 350 are implanted in the rotor wheels 341 in the circumferential direction to constitute a rotor blade cascade. Here, the center axis direction of the turbine rotor is hereinafter simply referred to as an axial direction.

The stator blade cascade and the rotor blade cascade are alternately provided in the turbine rotor axial direction. Then, the stator blade cascade and the rotor blade cascade immediately downstream from the stator blade cascade constitute a turbine stage. Note that the “downstream” means a downstream side with respect to a mainstream flow direction of a working fluid.

A combustion gas produced by a combustor (not illustrated) is guided through a transition piece (not illustrated) to a first-stage stator blade 322. The combustion gas flows downstream through an annular passage 328 while performing expansion work at the turbine stages. Then, the combustion gas having passed through the final-stage turbine stage is discharged to an exhaust hood 360.

Here, a part of the exhaust hood 360 is formed by the inner casing 311 and a packing head 370.

The packing head 370 is disposed annularly inside the inner casing 311 in a portion of forming the exhaust hood 360. The packing head 370 supports gland seals 380 sealing between the turbine rotor 340 and the packing head 370.

Further, also inside the axial end portion side of the outer casing 310, an annular packing head 371 is provided. Then, the packing head 371 supports a gland seal 381 sealing between the turbine rotor 340 and the packing head 371.

As illustrated in FIG. 11, on a downstream-side end face of the final-stage rotor wheel 341, a seal fin 342 projecting to the downstream side in the axial direction is provided. Further, on an upstream-side end face of the packing head 370, a seal fin 372 projecting to the upstream side in the axial direction is provided. Note that the “upstream” means an upstream side with respect to a mainstream flow direction of a working fluid.

A tip portion of the seal fin 342 is disposed so as to overlap with a tip portion of the seal fin 372 while having a gap in a radial direction to the extent of not being brought into contact therewith. Then, a seal part 391 is constituted by the tip portion of the seal fin 342 and the tip portion of the seal fin 372. Note that the radial direction is a direction perpendicular to the center axis O with the center axis O set as a reference point.

The seal part 391 suppresses inflow of the combustion gas discharged from the final-stage turbine stage, to a wheel space 390 further inside than the seal part 391.

Further, in the conventional axial flow turbine 300, a cooling medium is introduced to cool the turbine rotor 340.

A center passage 345 which makes the cooling medium flow in the axial direction is formed at the center of the turbine rotor 340. The center passage 345 is extended in the axial direction with the center axis O of the turbine rotor 340 set as a center axis, as illustrated in FIG. 11. Note that the cooling medium is supplied via a not-illustrated introduction passage to the center passage 345.

Here, in the conventional axial flow turbine 300, as the cooling medium, extraction steam from a system of the working fluid of the axial flow turbine 300 is used.

Further, the turbine rotor 340 is provided with a discharge passage 346 which discharges, the cooling medium flowing through the center passage 345 to a space 327 between the heat shield piece 325 and the turbine rotor 340. The discharge passage 346 is formed in the radial direction and communicated with the center passage 345. A plurality of discharge passages 346 are provided in the axial direction so as to allow the cooling medium to be discharged to the spaces 327 of the turbine stages.

Here, the cooling medium is ejected from the center passage 345 through the discharge passage 346 to the space 327. A part of the cooling medium ejected to the space 327 flows into the passage 328 through which the combustion gas flows. The remaining part of the cooling medium ejected to the space 327 flows through a communication hole 343 in the axial direction which is formed between the rotor wheel 341 and an implanted portion of the rotor blade 350 to the downstream-stage turbine stage.

Thus, the turbine rotor 340 and the rotor wheel 341 are cooled by the cooling medium.

For example, the cooling medium having passed through the communication hole 343 at the final-stage turbine stage flows into the wheel space 390. Then, the turbine members facing the wheel space 390 are cooled by the cooling medium.

A part of the cooling medium flowing into the wheel space 390 flows out through the seal part 391 to the exhaust hood 360. The remaining part of the cooling medium flowing into the wheel space 390 flows through the gland seals 380 to the gland seal 381 side.

In the conventional axial flow turbine 300, a surface on the exhaust hood 360 side of the packing head 370 becomes high temperatures by being exposed to the combustion gas. On the other hand, an inner peripheral side of the packing head 370 is cooled by the cooling medium flowing into the wheel space 390. Therefore, in the packing head 370, a temperature difference between an outer peripheral surface and an inner peripheral surface occurs, and the packing head 370 is sometimes deformed.

This also causes a change in a radial position of the seal fin 372 provided on the upstream-side end face of the packing head 370, for example. For example, when the seal fin 372 moves to the radial outside, the gap between the tip portion of the seal fin 372 and the tip portion of the seal fin 342 increases.

This causes the function as the seal part to be lowered. Then, when a pressure of the cooling medium flowing into the wheel space 390 is lower than a pressure of the combustion gas discharged from the final-stage turbine stage, the combustion gas discharged from the final-stage turbine stage flows into the wheel space 390. Note that the radial outside is a side away from the center axis O in the radial direction.

Further, in the conventional axial flow turbine 300, as described above, the cooling medium is ejected from the center passage 345 through the discharge passages 346 to the spaces 327. That is, the axial flow turbine 300 has a structure in which the cooling medium supplied to the one center passage 345 is distributed to the spaces 327 at the turbine stages. Therefore, a pressure (flow rate) of the cooling medium ejected to the space 327 at each of the turbine stages is regulated by adjusting a passage diameter of each of the discharge passages 346 or providing an orifice in each of the discharge passages 346.

Here, the extraction steam from the system of the working fluid of the axial flow turbine 300 is used as the cooling medium as described above. Therefore, for example, at a low load time of the axial flow turbine 300, a supply pressure of the cooling medium is dropped. However, the passage diameter of each of the discharge passages 346 is set according to the rated load condition, and thus, as the turbine stage lies further downstream, the cooling medium is not sufficiently supplied. Depending on operation conditions, the cooling medium is not sometimes supplied to the space 327.

This makes cooling of the turbine rotor 340 and the rotor wheel 341 at the turbine stage on the downstream-stage side insufficient. Moreover, an inflow rate of the cooling medium to the wheel space 390 on the downstream side at the final-stage turbine stage is reduced.

Due to the reduction in the inflow rate of the cooling medium to the wheel space 390, a pressure in the wheel space 390 is reduced. When the pressure in the wheel space 390 is lower than the pressure of the combustion gas discharged from the final-stage turbine stage, the combustion gas discharged from the final-stage turbine stage flows via the seal part 391 into the wheel space 390. This causes a temperature of the wheel space 390 to rise.

### BRIEF DESCRIPTION OF THE DRAWINGS

FIG. 1 is a system diagram of a gas turbine facility including an axial flow turbine of a first embodiment.

FIG. 2 is a view illustrating a meridian cross section of the axial flow turbine of the first embodiment.

FIG. 3 is a block diagram illustrating a configuration of a control unit of a cooling medium supply mechanism in the axial flow turbine of the first embodiment.

FIG. 4 is a flowchart explaining the operation based on a sensed signal from a temperature sensing unit in the cooling medium supply mechanism of the axial flow turbine of the first embodiment.

FIG. 5 is a flowchart explaining the operation based on a sensed signal from a pressure sensing unit or a load sensing unit in the cooling medium supply mechanism of the axial flow turbine of the first embodiment.

FIG. 6 is a view illustrating a meridian cross section of an axial flow turbine of a second embodiment.

FIG. 7 is a view illustrating a meridian cross section of an axial flow turbine of a third embodiment.

FIG. 8 is a view illustrating a meridian cross section of an axial flow turbine of a fourth embodiment.

FIG. 9 is a view illustrating a meridian cross section of an axial flow turbine of a fifth embodiment.

FIG. 10 is a view illustrating an A-A cross section of FIG. 9.

FIG. 11 is a view illustrating a meridian cross section of a conventional axial flow turbine.

### DETAILED DESCRIPTION

Hereinafter, embodiments of the present invention will be described with reference to the drawings.

In one embodiment, an axial flow turbine includes: a casing; a turbine rotor provided to penetrate in the casing; and a rotor wheel which protrudes from an outer peripheral surface of the turbine rotor to a radial outside over a circumferential direction and is formed in a plurality of stages in a turbine rotor axial direction, the rotor wheel having rotor blades in the circumferential direction.

Further, the axial flow turbine includes: a first seal part provided on a downstream side of the rotor wheel at a final stage with a predetermined gap apart from the rotor wheel, the first seal part sealing between the turbine rotor and the casing; a second seal part provided between the rotor wheel at the final stage and the first seal part, the second seal part preventing inflow to the turbine rotor side of a working fluid having passed through the rotor blade at the final stage; and a cooling medium supply mechanism which supplies a cooling medium directly to a space surrounded by the rotor wheel at the final stage, the turbine rotor, the first seal part and the second seal part.

### First Embodiment

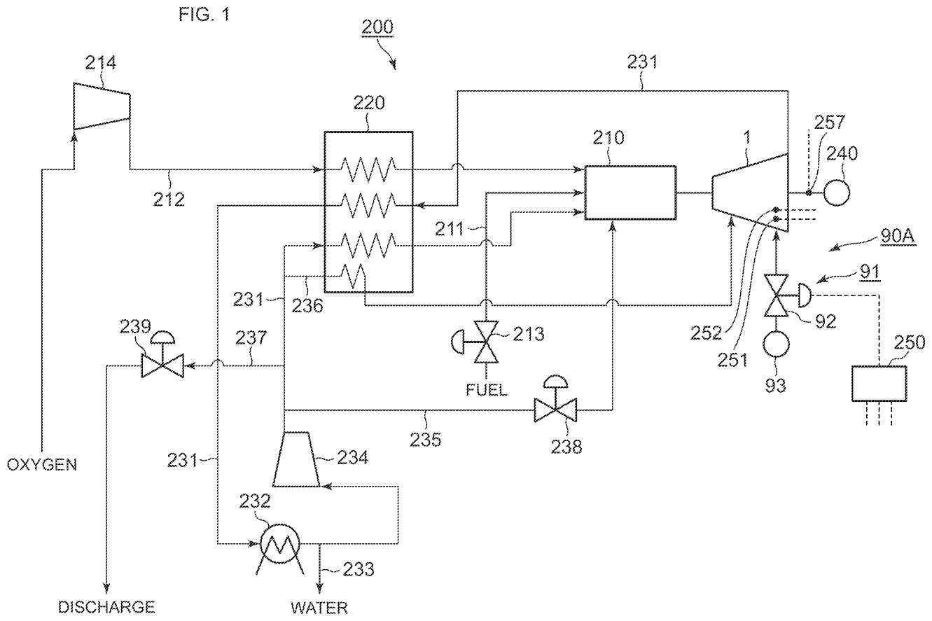

FIG. 1 is a system diagram of a gas turbine facility 200 including an axial flow turbine 1 of a first embodiment. Here, as the gas turbine facility 200, there is exemplified and described a supercritical CO₂ turbine facility including a configuration in which a part of CO₂ being a combustion product is circulated through a combustor 210 at a supercritical pressure.

As illustrated in FIG. 1, the gas turbine facility 200 includes the combustor 210 which combusts fuel and an oxidant, a pipe 211 which supplies the fuel to the combustor 210, and a pipe 212 which supplies the oxidant to the combustor 210.

The pipe 211 includes a flow rate regulating valve 213 which regulates a flow rate of the flue to be supplied into the combustor 210. Here, as the fuel, for example, hydrocarbon such as methane or natural gas is used. Further, as the fuel, for example, a coal gasification gas fuel containing carbon monoxide, hydrogen, and the like can also be used.

The pipe 212 is provided with a compressor 214 which pressurizes the oxidant. As the oxidant, for example, oxygen separated from the atmosphere by an air separating apparatus (not illustrated) is used. The oxidant flowing through the pipe 212 is heated by passing through a heat exchanger 220 to be supplied to the combustor 210.

The fuel and the oxidant guided to the combustor 210 undergo reaction (combustion), and are turned into a combustion gas. Here, in the gas turbine facility 200, a part of the combustion gas exhausted from the axial flow turbine 1 is circulated in the system. Therefore, in the combustion gas discharged from the combustor 210, excess oxidant (oxygen) and fuel preferably do not remain.

Thus, flow rates of the fuel and the oxidant are regulated so as to have a stoichiometric mixture ratio (equivalence ratio 1), for example. Note that the equivalence ratio which is mentioned here is an equivalence ratio when it is assumed that the fuel and the oxygen are mixed uniformly (overall equivalence ratio).

Further, the gas turbine facility 200 includes the axial flow turbine 1, a generator 240, a heat exchanger 220, a cooler 232, and a compressor 234. Moreover, the gas turbine facility 200 includes a pipe 231 for circulating a part of the combustion gas discharged from the axial flow turbine 1 in the system.

The axial flow turbine 1 is moved rotationally by the combustion gas discharged from the combustor 210. For example, the generator 240 is coupled to the axial flow turbine 1. The combustion gas discharged from the combustor 210, which is mentioned here, contains a combustion product produced from the fuel and the oxidant and carbon dioxide to be circulated in the combustor 210 (a combustion gas from which water vapor has been removed). Note that the axial flow turbine 1 includes a later-described cooling medium supply mechanism 90A.

The combustion gas discharged from the axial flow turbine 1 is guided to the pipe 231, and cooled by passing through the heat exchanger 220. At this time, the oxidant flowing through the pipe 212 and the carbon dioxide flowing through the pipe 231 to be circulated through the combustor 210 are heated by heat release from the combustion gas.

The combustion gas having passed through the heat exchanger 220 passes through the cooler 232. By the combustion gas passing through the cooler 232, water vapor contained in the combustion gas is removed therefrom. At this time, the water vapor in the combustion gas condenses into water. The water is discharged through a pipe 233 to the outside, for example.

Here, as described previously, when the flow rates of the fuel and the oxidant are regulated so as to have a stoichiometric mixture ratio (equivalence ratio 1), most of components of the combustion gas from which the water vapor has been removed (dry combustion gas) are carbon dioxide. Note that a slight amount of carbon monoxide or the like is sometimes mixed in the combustion gas from which the water vapor has been removed, for example, but, hereinafter, the combustion gas from which the water vapor has been removed is simply referred to as carbon dioxide.

The carbon dioxide is pressurized to a pressure equal to or more than the critical pressure by the compressor 234 interposed in the pipe 231 to become a supercritical fluid. Here, as illustrated in FIG. 1, the pipe 231 is made to branch off on the downstream side of the compressor 234 to constitute a first branch pipe 235, a second branch pipe 236, and a third branch pipe 237.

The pressurized carbon dioxide flowing through the pipe 231 is heated in the heat exchanger 220. Then, the carbon dioxide flowing through the pipe 231 is guided to the combustor 210 as the cooling medium, for example. The temperature of the carbon dioxide having passed through the heat exchanger 220 becomes, for example, about 700° C.

The pressurized carbon dioxide flowing through the first branch pipe 235 is guided to the combustor 210 as the cooling medium after its flow rate is regulated by a flow rate regulating valve 238. The temperature of the carbon dioxide flowing through the first branch pipe 235 is, for example, about 400° C.

The pressurized carbon dioxide flowing through the second branch pipe 236 is heated in the heat exchanger 220. Here, a temperature at an outlet of the heat exchanger 220 of the carbon dioxide flowing through the second branch pipe 236 is configured to be lower than a temperature at an outlet of the heat exchanger 220 of the carbon dioxide flowing through the pipe 231.

The carbon dioxide flowing through the second branch pipe 236 is, though described later, used for cooling the turbine rotor of the axial flow turbine 1, or the like, for example.

The pressurized carbon dioxide flowing through the third branch pipe 237 is discharged to the outside after its flow rate is regulated by a flow rate regulating valve 239. The carbon dioxide discharged to the outside can be utilized for EOR (Enhanced Oil Recovery) or the like employed at an oil drilling field, for example.

Next, a configuration of the axial flow turbine 1 is described.

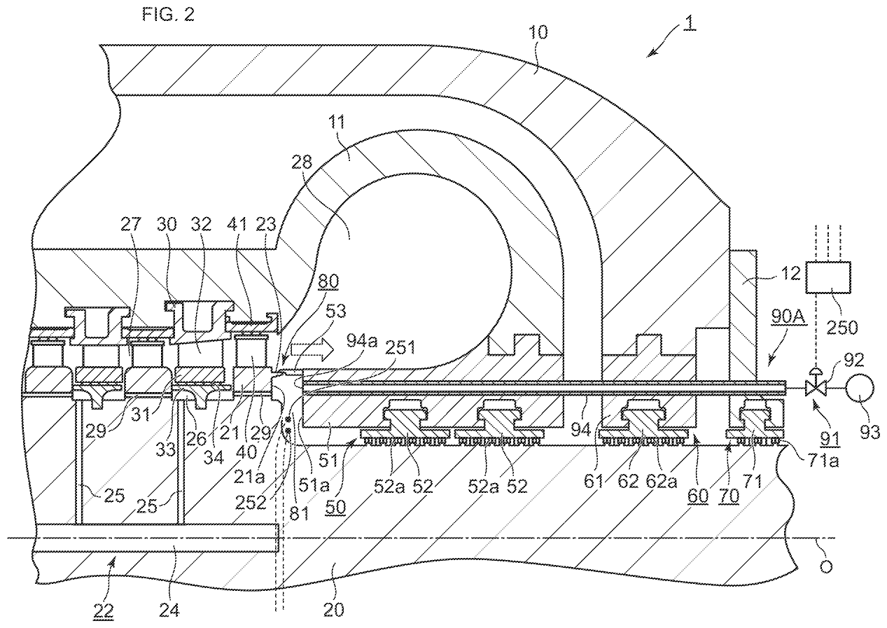

FIG. 2 is a view illustrating a meridian cross section of an axial flow turbine 1 of the first embodiment. Note that FIG. 2 illustrates a turbine structure of a gas turbine.

As illustrated in FIG. 2, the axial flow turbine 1 includes an outer casing 10 and an inner casing 11 inside the outer casing 10. The axial flow turbine 1 includes a packing casing 12 in the axial outside of the outer casing 10.

Further, a turbine rotor 20 is provided to penetrate the inner casing 11, the outer casing 10, and the packing casing 12.

An outer shroud 30 is provided on an inner periphery of the inner casing 11 over a circumferential direction. An inner shroud 31 is provided in the inside (radial inside) of the outer shroud 30 over the circumferential direction. Then, between the outer shrouds 30 and the inner shrouds 31, a plurality of stator blades 32 are supported in the circumferential direction to constitute a stator blade cascade. The stator blade cascade is provided in a plurality of stages in the axial direction (the center axis O direction of the turbine rotor 20).

Here, the radial inside is a side approaching the center axis O (center axis O side) in the radial direction.

Inside the inner shroud 31, for example, a heat shield piece 33 is provided over the circumferential direction opposite to the inner shroud 31. The heat shield piece 33 is implanted in the turbine rotor 20, for example. A sealing portion 34 is formed between the inner shroud 31 and the heat shield piece 33.

Further, on a downstream side of the final-stage rotor blade 40, an exhaust hood 28 to which the combustion gas having passed through the final-stage turbine stage is discharged is formed. A part of the exhaust hood 28 is formed by the inner casing 11 and a later-described packing head 51.

The turbine rotor 20 includes a rotor wheel 21 and a cooling structure portion 22. Note that both ends of the turbine rotor 20 are supported rotatably by bearings (not illustrated).

The rotor wheel 21 protrudes from an outer peripheral surface of the turbine rotor 20 to the radial outside over the circumferential direction. The rotor wheel 21 constituted by an annular protruding body is provided in a plurality of stages in the axial direction.

A plurality of rotor blades 40 are implanted on tip portions of the rotor wheels 21 in the circumferential direction to constitute a rotor blade cascade. An outer periphery of the rotor blade 40 is surrounded by a shroud segment 41, for example. The shroud segment 41 is supported by the outer shroud 30 and the inner casing 11.

Further, when the rotor blade 40 is implanted, a communication hole 29 communicated with the downstream-stage turbine stage is formed between an implanted portion of the rotor blade 40 and the rotor wheel 21 as illustrated in FIG. 2, for example.

Incidentally, the stator blade cascade and the rotor blade cascade are alternately provided in the axial direction. Then, the stator blade cascade and the rotor blade cascade immediately downstream from the stator blade cascade constitute a turbine stage.

The cooling structure portion 22 of the turbine rotor 20 includes an introduction passage (not illustrated), an axial passage 24, and a discharge passage 25. The introduction passage, the axial passage 24 and the discharge passage 25 are communicated with each other.

The introduction passage is a passage which introduces the cooling medium to the axial passage 24. The introduction passage is constituted by a through hole penetrating from the outer peripheral surface of the turbine rotor 20 to the axial passage 24, for example. Note that the carbon dioxide supplied from the second branch pipe 236 illustrated in FIG. 1 into the axial flow turbine 1 is introduced to the introduction passage.

The axial passage 24 is extended in the axial direction with the center axis O of the turbine rotor 20 set as a center axis, as illustrated in FIG. 2.

The discharge passage 25 is formed from the axial passage 24 toward the radial outside. Then, an outlet of the discharge passage 25 is open to a space 26 surrounded by the rotor wheel 21, the heat shield piece 33, and the outer peripheral surface of the turbine rotor. Further, these discharge passages 25 are included in the axial direction corresponding to the turbine stages.

As illustrated in FIG. 2, between the turbine rotor 20 and the inner casing 11, between the turbine rotor 20 and the outer casing 10, and between the turbine rotor 20 and the packing casing 12, gland seal parts 50, 60, 70 which suppress leakage of a working fluid to the outside are included.

The gland seal part 50 between the turbine rotor 20 and the inner casing 11 includes a packing head 51 and sealing members 52. Note that the gland seal part 50 functions as a first seal part.

The gland seal part 50 seals between the turbine rotor 20 and the inner casing 11. The gland seal part 50 is provided annularly in the inside (radial inside) of the inner casing 11.

The packing head 51 is constituted by an annular member and provided in the inside (radial inside) of the inner casing 11. The packing head 51 is provided on a downstream side in the axial direction of the final-stage rotor wheel 21 with a predetermined gap apart from this rotor wheel 21.

The sealing member 52 is provided between the turbine rotor 20 and the packing head 51 over the circumferential direction. The sealing member 52 is supported by the packing head 51. Further, the sealing member 52 includes a labyrinth fin 52a on the turbine rotor 20 side, for example.

Further, as illustrated in FIG. 2, the packing head 51 includes a seal fin 53 protruding from an upstream-side end face 51a to the upstream side in the axial direction. The seal fin 53 is disposed on the radial outside within the upstream-side end face 51a having a thickness in the radial direction, for example. Note that the seal fin 53 functions as a first seal fin.

Here, the final-stage rotor wheel 21 includes a seal fin 23 protruding from a downstream-side end face 21a to the downstream side in the axial direction. The seal fin 23 is disposed on the radial outside within the downstream-side end face 21a, for example. Note that the seal fin 23 functions as a second seal fin.

A tip portion of the seal fin 23 is disposed to be displaced in a radial direction to the extent of not being brought into contact with a tip portion of the seal fin 53. In other words, the tip portion of the seal fin 23 is disposed so as to overlap with the tip portion of the seal fin 53 while having a gap in the radial direction to the extent of not being brought into contact therewith.

Then, a seal part 80 is constituted by the tip portion of the seal fin 23 and the tip portion of the seal fin 53. Thus, the seal part 80 is provided between the final-stage rotor wheel 21 and the packing head 51. Note that the seal part 80 functions as a second seal part.

Here, a wheel space 81 surrounded by the seal part 80, the final-stage rotor wheel 21, the gland seal part 50, and the turbine rotor is formed between the final-stage rotor wheel 21 and the gland seal part 50.

Then, the seal part 80 prevents inflow to the turbine rotor 20 side of the combustion gas (working fluid) having passed through the final-stage rotor blade 40. That is, the seal part 80 suppresses inflow of the combustion gas discharged from the final-stage turbine stage, to the wheel space 81.

The gland seal part 60 between the turbine rotor 20 and the outer casing 10 includes a packing head 61 and a sealing member 62.

The gland seal part 60 seals between the turbine rotor 20 and the outer casing 10. The gland seal part 60 is provided annularly in the inside (radial inside) of the outer casing 10.

The packing head 61 is constituted by an annular member and provided on the inside (radial inside) of the outer casing 10.

The sealing member 62 is provided between the turbine rotor 20 and the packing head 61 over the circumferential direction. The sealing member 62 is supported by the packing head 61. Further, the sealing member 62 includes a labyrinth fin 62a on the turbine rotor 20 side, for example.

The gland seal part 70 between the turbine rotor 20 and the packing casing 12 includes a sealing member 71.

The gland seal part 70 seals between the turbine rotor 20 and the packing casing 12. The gland seal part 70 is provided annularly in the inside (radial inside) of the packing casing 12.

The sealing member 71 is provided between the turbine rotor 20 and the packing casing 12 over the circumferential direction. The sealing member 71 is supported by the packing casing 12. Further, the sealing member 71 includes a labyrinth fin 71a on the turbine rotor 20 side, for example.

Further, the axial flow turbine 1 includes a cooling medium supply mechanism 90A which supplies the cooling medium directly to the wheel space 81.

The cooling medium supply mechanism 90A includes an introduction passage 91, a pressure regulating valve 92, a cooling medium supply source 93, a control unit 250, and a sensing unit, as illustrated in FIG. 2.

First, the introduction passage 91, the pressure regulating valve 92, and the cooling medium supply source 93 are described.

The introduction passage 91 introduces the cooling medium from the cooling medium supply source 93 to the wheel space 81. The introduction passage 91 is constituted of the introduction pipe 94, for example. The introduction pipe 94 is provided to penetrate the packing casing 12, the packing head 61, and the packing head 51 along the axial direction, for example. Then, one end 94a of the introduction pipe 94 is open into the wheel space 81. The one end 94a of the introduction pipe 94 functions as an outlet of the introduction passage 91.

Incidentally, here, one example in which the introduction passage 91 is constituted of the introduction pipe 94 is indicated, but this configuration is not restrictive.

For example, the introduction passage 91 in the packing head 61 and the packing head 51 may be constituted by introduction holes. That is, a part of the introduction passage 91 may be constituted by a hole.

In this case, the introduction passage 91 is constituted by an introduction pipe from the outside through the packing casing 12 to the introduction hole formed in the packing head 61. The communication between the packing head 51 and the packing head 61 is constituted by an introduction pipe.

Further, the introduction pipe which communicates the packing head 51 and the packing head 61 with each other may be constituted by a flexible pipe capable of expansion and contraction in the axial direction, or the like, for example. This makes it possible to, even when a thermal expansion difference occurs in the inner casing 11 and the outer casing 10 in the axial direction, absorb the thermal expansion difference.

The pressure regulating valve 92 regulates a pressure of the cooling medium supplied to the wheel space 81. The pressure regulating valve 92 is interposed in the introduction passage 91. An opening degree of the pressure regulating valve 92 is set so as to allow the cooling medium at a predetermined pressure (a pressure equal to or more than a later-described threshold pressure) to be supplied into the wheel space 81 when the pressure regulating valve 92 is opened, for example. The pressure regulating valve 92 is controlled based on a control signal from the control unit 250, for example.

The cooling medium supply source 93 supplies the cooling medium to the introduction passage 91. The cooling medium supply source 93 may be a system of the axial flow turbine 1, for example. That is, the cooling medium supplied to the introduction passage 91 may be a working medium extracted from the system of the axial flow turbine 1.

Further, the cooling medium supply source 93 may be a supply source other than the system of the axial flow turbine 1, for example.

Here, when the cooling medium supply source 93 is constituted by the system of the axial flow turbine 1, an extraction section from the system is set so that the pressure of the cooling medium supplied to the wheel space 81 is higher than a pressure of the combustion gas at an inlet of the exhaust hood 28.

For example, when the axial flow turbine 1 is the supercritical CO₂ turbine illustrated in FIG. 1, CO₂ at a supercritical pressure which is extracted from the system is used as the cooling medium.

Further, in the case of the supercritical CO₂ turbine, the oxidant extracted from the system may be used as the cooling medium. In this case, for example, the oxidant is extracted from the pipe 212 on a downstream side of the compressor 214 (refer to FIG. 1).

Further, for example, when the axial flow turbine 1 is a typical gas turbine, air extracted from a compressor, or the like is used as the cooling medium.

Further, also when the cooling medium supply source 93 is constituted by the supply source other than the system of the axial flow turbine 1, a pressure of the supply source is set so that the pressure of the cooling medium supplied to the wheel space 81 is higher than the pressure of the combustion gas at the inlet of the exhaust hood 28.

Here, the cooling medium to be supplied from the cooling medium supply source 93 may be subjected to temperature regulation. In this case, the cooling medium supply mechanism 90A may include a temperature regulating mechanism such as a heat exchanger.

Next, the control unit 250 and the sensing unit are described.

Here, the cooling medium supply mechanism 90A supplies the cooling medium to the wheel space 81 or blocks the supply of the cooling medium to the wheel space 81 based on a temperature, a pressure in the wheel space 81 or a load of the axial flow turbine 1.

When the cooling medium is supplied to the wheel space 81, the pressure regulating valve 92 is opened. On the other hand, when the supply of the cooling medium to the wheel space 81 is blocked, the pressure regulating valve 92 is closed.

The control unit 250 controls the pressure regulating valve 92 based on a sensed signal from the sensing unit.

The sensing unit is constituted of a temperature sensing unit 251 which senses a temperature, a pressure sensing unit 252 which senses a pressure, and a load sensing unit 257 which senses a load of the axial flow turbine 1, for example. The load sensing unit 257 senses the load of the axial flow turbine 1 based on a turbine output, for example.

Incidentally, the sensing unit may be constituted of one of these sensing units. Further, the sensing unit may be constituted of two or more of these sensing units.

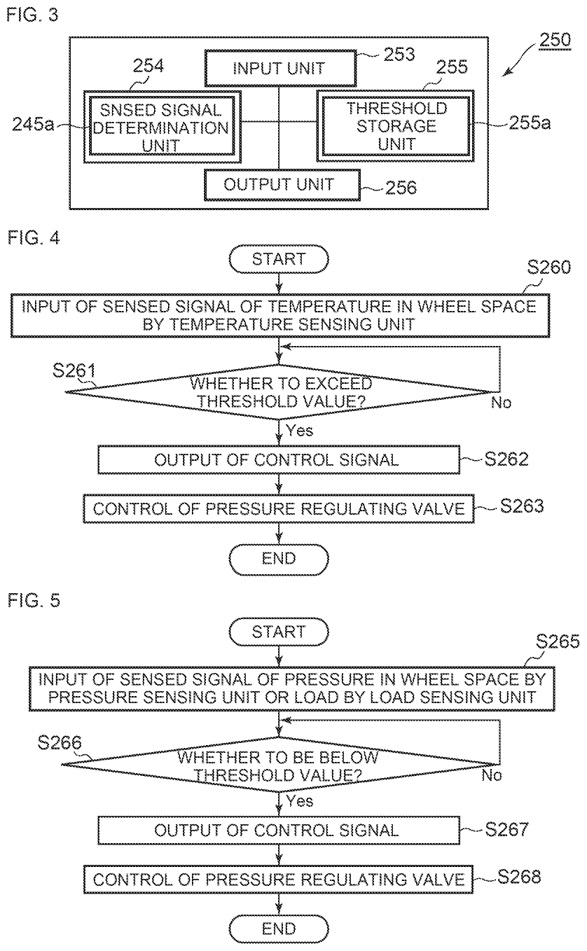

Here, FIG. 3 is a block diagram illustrating a configuration of the control unit 250 of the cooling medium supply mechanism 90A in the axial flow turbine 1 of the first embodiment. FIG. 4 is a flowchart explaining the operation based on a sensed signal from the temperature sensing unit 251 in the cooling medium supply mechanism 90A of the axial flow turbine 1 of the first embodiment. FIG. 5 is a flowchart explaining the operation based on a sensed signal from the pressure sensing unit 252 or the load sensing unit 257 in the cooling medium supply mechanism 90A of the axial flow turbine 1 of the first embodiment.

As illustrated in FIG. 3, the control unit 250 includes an input unit 253, a calculation unit 254, a storage unit 255, and an output unit 256.

The input unit 253 receives sensed signals from the various sensing units. Specifically, the input unit 253 receives the sensed signals from the temperature sensing unit 251, the pressure sensing unit 252, the load sensing unit 257, and so on.

The storage unit 255 is constituted by a storage medium such as a read-only memory (ROM) or a random access memory (RAM). The storage unit 255 includes a threshold storage unit 255a.

The threshold storage unit 255a provides a reference value for determination in a sensed signal determination unit 254a of the calculation unit 254. The threshold storage unit 255a stores a temperature threshold value, a pressure threshold value, a load threshold value and so on which are each used as a reference for opening and closing the pressure regulating valve 92, for example.

Here, the temperature threshold value is set to a maximum limit temperature allowable as a temperature in the wheel space 81. Note that the temperature threshold value can be set regardless of the load of the axial flow turbine 1, for example.

Then, when the temperature in the wheel space 81 exceeds the temperature threshold value, the pressure regulating valve 92 is opened. Note that when the temperature in the wheel space 81 exceeds the temperature threshold value, it is assumed that the combustion gas is flowing from the seal part 80 at the inlet of the exhaust hood 28 into the wheel space 81, for example.

The pressure threshold value is set to a minimum limit pressure allowable as a pressure in the wheel space 81. The pressure threshold value is set to a higher pressure than a pressure of the combustion gas at the inlet of the exhaust hood 28, for example. That is, the pressure threshold value is set to the minimum limit pressure to the extent that the combustion gas does not flow from the seal part 80 at the inlet of the exhaust hood 28 into the wheel space 81. Note that the pressure threshold value can be set regardless of the load of the axial flow turbine 1, for example.

Then, when the pressure in the wheel space 81 is below the pressure threshold value, the pressure regulating valve 92 is opened. Note that when the pressure in the wheel space 81 is below the pressure threshold value, it is assumed that the combustion gas is flowing from the seal part 80 at the inlet of the exhaust hood 28 into the wheel space 81, for example.

The load threshold value is set to a load of the axial flow turbine 1 when the temperature in the wheel space 81 is the above-described temperature threshold value, for example. Further, the load threshold value is set to a load of the axial flow turbine 1 when the pressure in the wheel space 81 is the above-described pressure threshold value, for example.

Then, when the load of the axial flow turbine 1 is below the load threshold value, the pressure regulating valve 92 is opened. Note that when the load of the axial flow turbine 1 is below the load threshold value, it is assumed that the combustion gas is flowing from the seal part 80 at the inlet of the exhaust hood 28 into the wheel space 81, for example.

The calculation unit 254 executes various kinds of calculation processing by using programs, data, or the like stored in the storage unit 255, for example. The calculation unit 254 includes a sensed signal determination unit 254a.

The sensed signal determination unit 254a determines whether or not to exceed the temperature threshold value used as the reference for opening and closing the pressure regulating valve 92 based on a sensed signal from the temperature sensing unit 251. The sensed signal determination unit 254a determines whether or not to be below the pressure threshold value used as the reference for opening and closing the pressure regulating valve 92 based on a sensed signal from the pressure sensing unit 252. The sensed signal determination unit 254a determines whether or not to be below the load threshold value used as the reference for opening and closing the pressure regulating valve 92 based on a sensed signal from the load sensing unit 257.

Then, the sensed signal determination unit 254a outputs a control signal for opening the pressure regulating valve 92 or a control signal to close the pressure regulating valve 92 to the output unit 256.

The output unit 256 outputs the control signal for opening the pressure regulating valve 92 or the control signal to close the pressure regulating valve 92, which is output from the sensed signal determination unit 254a, to the pressure regulating valve 92.

Here, the processing to be executed by the above-described control unit 250 is implemented by a computer device or the like, for example.

Here, the operation of the cooling medium supply mechanism 90A is described.

Here, there are described a case of being controlled based on the sensed signal from the temperature sensing unit 251 (refer to FIG. 4), a case of being controlled based on the sensed signal from the pressure sensing unit 252 (refer to FIG. 5), and a case of being controlled based on the sensed signal from the load sensing unit 257 (refer to FIG. 5).

As a time of operating the cooling medium supply mechanism 90A, for example, the time from starting the axial flow turbine 1 to becoming a predetermined load can be cited. Further, as the time of operating the cooling medium supply mechanism 90A, for example, the time when a load is below the predetermined load in stopping the axial flow turbine 1 be cited.

(The case of being controlled based on the sensed signal from the temperature sensing unit 251)

As illustrated in FIG. 4, the input unit 253 receives the sensed signal from the temperature sensing unit 251 (Step S260).

The sensed signal determination unit 254a determines whether or not a sensed temperature exceeds the temperature threshold value based on the sensed signal received by the input unit 253 and the temperature threshold value stored in the threshold storage unit 255a (Step S261).

When the sensed signal determination unit 254a determines not to exceed the temperature threshold value in the determination in Step S261 (No in Step S261), the sensed signal determination unit 254a executes the processing in Step S261 again.

When the sensed signal determination unit 254a determines to exceed the temperature threshold value in the determination in Step S261 (Yes in Step S261), the sensed signal determination unit 254a outputs the control signal for opening a valve of the pressure regulating valve 92 to the output unit 256 (Step S262).

The output unit 256 outputs the control signal from the sensed signal determination unit 254a to the pressure regulating valve 92 to open the pressure regulating valve 92 (Step S263).

Here, when the temperature in the wheel space 81 is equal to or less than the temperature threshold value, the sensed signal determination unit 254a outputs the control signal for closing the valve via the output unit 256 to the pressure regulating valve 92. Therefore, when the temperature in the wheel space 81 is equal to or less than the temperature threshold value, the cooling medium is not supplied from the cooling medium supply mechanism 90A into the wheel space 81.

(The case of being controlled based on the sensed signal from the pressure sensing unit 252)

As illustrated in FIG. 5, the input unit 253 receives the sensed signal from the pressure sensing unit 252 (Step S265).

The sensed signal determination unit 254a determines whether or not a sensed pressure is below the pressure threshold value based on the sensed signal received by the input unit 253 and the pressure threshold value stored in the threshold storage unit 255a (Step S266).

When the sensed signal determination unit 254a determines not to be below the pressure threshold value in the determination in Step S266 (No in Step S266), the sensed signal determination unit 254a executes the processing in Step S266 again.

When the sensed signal determination unit 254a determines to be below the pressure threshold value in the determination in Step S266 (Yes in Step S266), the sensed signal determination unit 254a outputs the control signal for opening the valve of the pressure regulating valve 92 to the output unit 256 (Step S267).

The output unit 256 outputs the control signal from the sensed signal determination unit 254a to the pressure regulating valve 92 to open the pressure regulating valve 92 (Step S268).

Here, when the pressure in the wheel space 81 is equal to or more than the pressure threshold value, the sensed signal determination unit 254a outputs the control signal for closing the valve via the output unit 256 to the pressure regulating valve 92.

Therefore, when the pressure in the wheel space 81 is equal to or more than the pressure threshold value, the cooling medium is not supplied from the cooling medium supply mechanism 90A into the wheel space 81.

(The case of being controlled based on the sensed signal from the load sensing unit 257)

As illustrated in FIG. 5, the input unit 253 receives the sensed signal from the load sensing unit 257 (Step S265).

The sensed signal determination unit 254a determines whether or not a sensed load is below the load threshold value based on the sensed signal received by the input unit 253 and the load threshold value stored in the threshold storage unit 255a (Step S266).

When the sensed signal determination unit 254a determines not to be below the load threshold value in the determination in Step S266 (No in Step S266), the sensed signal determination unit 254a executes the processing in Step S266 again.

When the sensed signal determination unit 254a determines to be below the load threshold value in the determination in Step S266 (Yes in Step S266), the sensed signal determination unit 254a outputs the control signal for opening the valve of the pressure regulating valve 92 to the output unit 256 (Step S267).

The output unit 256 outputs the control signal from the sensed signal determination unit 254a to the pressure regulating valve 92 to open the pressure regulating valve 92 (Step S268).

Here, when the load of the axial flow turbine 1 is equal to or more than the load threshold value, the sensed signal determination unit 254a outputs the control signal for closing the valve via the output unit 256 to the pressure regulating valve 92. Therefore, when the load of the axial flow turbine 1 is equal to or more than the load threshold value, the cooling medium is not supplied from the cooling medium supply mechanism 90A into the wheel space 81.

Here, as described above, one example of being controlled based on any of the temperature sensing signal, the pressure sensing signal, and the load sensing signal is indicated, but this configuration is not restrictive. In the cooling medium supply mechanism 90A, for example, the control may be performed based on two or more sensed signals of the temperature sensing signal, the pressure sensing signal, and the load sensing signal.

For example, the control unit 250 blocks the supply of the cooling medium to the wheel space 81 when the temperature in the wheel space 81 is equal to or less than the temperature threshold value and the pressure in the wheel space 81 is equal to or more than the pressure threshold value.

Further, the control unit 250 supplies the cooling medium to the wheel space 81 when the temperature in the wheel space 81 is equal to or less than the temperature threshold value and the pressure in the wheel space 81 is below the pressure threshold value. On one hand, the control unit 250 supplies the cooling medium to the wheel space 81 regardless of the pressure in the wheel space 81 when the temperature in the wheel space 81 exceeds the temperature threshold value.

Further, the control unit 250 blocks the supply of the cooling medium to the wheel space 81 when the load of the axial flow turbine 1 is equal to or more than the load threshold value and the pressure in the wheel space 81 is equal to or more than the pressure threshold value. Further, the control unit 250 supplies the cooling medium to the wheel space 81 when the load of the axial flow turbine 1 is equal to or more than the load threshold value and the pressure in the wheel space 81 is below the pressure threshold value.

Moreover, the control unit 250 blocks the supply of the cooling medium to the wheel space 81 when the load of the axial flow turbine 1 is equal to or more than the load threshold value and the temperature in the wheel space 81 is equal to or less than the temperature threshold value. Further, the control unit 250 supplies the cooling medium to the wheel space 81 when the load of the axial flow turbine 1 is equal to or more than the load threshold value and the temperature in the wheel space 81 exceeds the temperature threshold value.

On one hand, the control unit 250 supplies the cooling medium to the wheel space 81 regardless of the pressure or the temperature in the wheel space 81 when the load of the axial flow turbine 1 is below the load threshold value.

Next, the operation of the axial flow turbine 1 is described with reference to FIG. 2.

Here, a case where the cooling medium supply mechanism 90A does not operate and a case where the cooling medium supply mechanism 90A operates are described.

(The case where the cooling medium supply mechanism 90A does not operate)

The case where the cooling medium supply mechanism 90A does not operate is a case where the cooling medium is not supplied into the wheel space 81 in the operations of the above-described cooling medium supply mechanism 90A (FIG. 4, FIG. 5).

The combustion gas produced by the combustor (not illustrated) is introduced through a transition piece (not illustrated) into the axial flow turbine 1. The combustion gas introduced into the axial flow turbine 1 flows through a passage 27 including the stator blades 32 and the rotor blades 40, and rotates the turbine rotor 20 while performing expansion work. The combustion gas having passed through the final-stage rotor blade 40 is discharged through the exhaust hood 28 from the axial flow turbine 1.

Meanwhile, the cooling medium guided from the introduction passage (not illustrated) to the axial passage 24 is ejected through the discharge passage 25 to the space 26. A part of the cooling medium ejected to the space 26 flows into the passage 27 through which the combustion gas flows. The remaining part of the cooling medium ejected to the space 26 flows through the communication hole 29 to the downstream-stage turbine stage. Thus, the turbine rotor 20 and the rotor wheel 21 are cooled by the cooling medium.

Further, the cooling medium having passed through the communication hole 29 at the final-stage turbine stage flows into the wheel space 81. Then, the turbine members facing the wheel space 81 are cooled by the cooling medium.

A part of the cooling medium flowing from the communication hole 29 into the wheel space 81 flows out from the seal part 80 to the exhaust hood 360. The cooling medium flowing out from the seal part 80 to the exhaust hood 28 flows through the exhaust hood 28 to be discharged to the outside of the axial flow turbine 1 together with the combustion gas having passed through the final-stage rotor blade 40. The cooling medium flows out from the seal part 80 to the exhaust hood 28, thereby making it possible to prevent the inflow into the wheel space 81 of the combustion gas having passed through the final-stage rotor blade 40.

The remaining part of the cooling medium flows toward the outside (gland seal part 60 side) between the gland seal part 50 and the turbine rotor 20.

The cooling medium having passed through between the gland seal part 50 and the turbine rotor 20 flows between the gland seal part 60 and the turbine rotor 20 and between the gland seal part 70 and the turbine rotor 20 to flow out to the outside.

(The case where the cooling medium supply mechanism 90A operates)

The case where the cooling medium supply mechanism 90A operates is a case where the cooling medium is supplied into the wheel space 81 in the operations of the above-described cooling medium supply mechanism 90A (FIG. 4, FIG. 5).

Here, the action of the combustion gas introduced into the axial flow turbine 1 is similar to that in the case where the cooling medium supply mechanism 90A does not operate.

The cooling medium guided from the introduction passage (not illustrated) to the axial passage 24 is ejected through the discharge passage 25 to the space 26. Here, the discharge passage 25 located at the upstream turbine stage can supply the cooling medium to the space 26.

On the other hand, for example, at a starting time or a low load time of the axial flow turbine 1, as the turbine stage lies further downstream, the cooling medium is not sufficiently supplied from the discharge passage 25 to the space 26 in some cases. Moreover, depending on operation conditions, the cooling medium is not sometimes supplied from the discharge passage 25 to the space 26 either.

Thus, by operating the cooling medium supply mechanism 90A, the cooling medium at a pressure equal to or more than the pressure threshold value is supplied into the wheel space 81.

Specifically, a pressure of the cooling medium supplied from the cooling medium supply source 93 to the introduction passage 91 (introduction pipe 94) is regulated by the pressure regulating valve 92. The cooling medium whose pressure has been regulated is ejected from the outlet of the introduction passage 91 (the one end 94a of the introduction pipe 94) into the wheel space 81. Note that the pressure of the cooling medium to be ejected via the pressure regulating valve 92 to the wheel space 81 is higher than the pressure threshold value.

The cooling medium ejected into the wheel space 81 cools the turbine members and the turbine rotor 20 facing the wheel space 81 as previously described. Further, the cooling medium ejected into the wheel space 81 flows out from the seal part 80 to the exhaust hood 28. Moreover, the cooling medium ejected into the wheel space 81 flows toward the outside between the gland seal parts 50, 60, 70 and the turbine rotor 20 to flow out to the outside.

Further, for example, when the cooling medium is not supplied from the discharge passage 25 to the space 26 at the downstream turbine stage, a part of the cooling medium ejected into the wheel space 81 flows through the communication hole 29 at the final-stage turbine stage to the upstream side to flow into the space 26. Then, the cooling medium flowing into the space 26 flows out to the passage 27.

For example, when the cooling medium is not supplied to the space 26 at the stage further upstream than the final stage by one stage (the previous stage to the final stage), the pressure of the cooling medium ejected to the wheel space 81 is set to be higher than a pressure of the combustion gas flowing through the passage 27 at the turbine stage where the space 26 at the previous stage to the final stage is located.

This causes the cooling medium to flow from the wheel space 81 through the final-stage communication hole 29 to the upstream side and flow into the final-stage space 26. Moreover, a part of the cooling medium flowing into the final-stage space 26 flows through the communication hole 29 at the previous stage to the final stage to the upstream side and flows into the space 26 at the previous stage to the final stage.

Here, the control unit 250 may include a position determination unit which determines a turbine stage having the space 26 to which the cooling medium is not introduced based on the pressure in the wheel space 81 and the load of the axial flow turbine 1, in the calculation unit 254, for example. In this case, the control unit 250 includes a position determination storage unit which stores the data for determining the turbine stage having the space 26 to which the cooling medium is not introduced based on the pressure in the wheel space 81 and the load of the axial flow turbine 1, in the storage unit 255.

Then, the sensed signal determination unit 254a outputs the control signal via the output unit 256 to the pressure regulating valve 92 so that a pressure of the cooling medium to be supplied to the wheel space 81 gets a pressure capable of flowing into the turbine stage determined by the position determination unit.

Incidentally, the pressure of the cooling medium ejected to the wheel space 81 is set in consideration of a pressure loss produced when the cooling medium passes through the communication hole 29 and the space 26.

As described above, even under the situation where the cooling medium cannot be supplied from the cooling structure portion 22 to the wheel space 81, including the cooling medium supply mechanism 90A allows the cooling medium to be supplied to the wheel space 81. This makes it possible to cool the turbine members and the turbine rotor 20 facing the wheel space 81 regardless of the load of the axial flow turbine 1.

Further, the pressure of the cooling medium in the wheel space 81 is higher than the pressure of the combustion gas having passed through the final-stage rotor blade 40, thereby preventing the combustion gas having passed through the final-stage rotor blade 40 from flowing into the wheel space 81. Moreover, for example, even when the packing head 51 is deformed due to a temperature difference between an outer peripheral surface and an inner peripheral surface of the packing head 51 to lower a seal function of the seal part 80, the combustion gas having passed through the final-stage rotor blade 40 is prevented from flowing into the wheel space 81.

As described above, according to the axial flow turbine 1 of the first embodiment, including the cooling medium supply mechanism 90A allows the cooling medium at an optimum pressure to be supplied directly into the wheel space 81 regardless of the load of the axial flow turbine 1. This enables accurate cooling of the turbine rotor 20, the gland seal part 50, and the like. Further, the combustion gas having passed through the final-stage rotor blade 40 can also be prevented from flowing into the wheel space 81.

### Second Embodiment

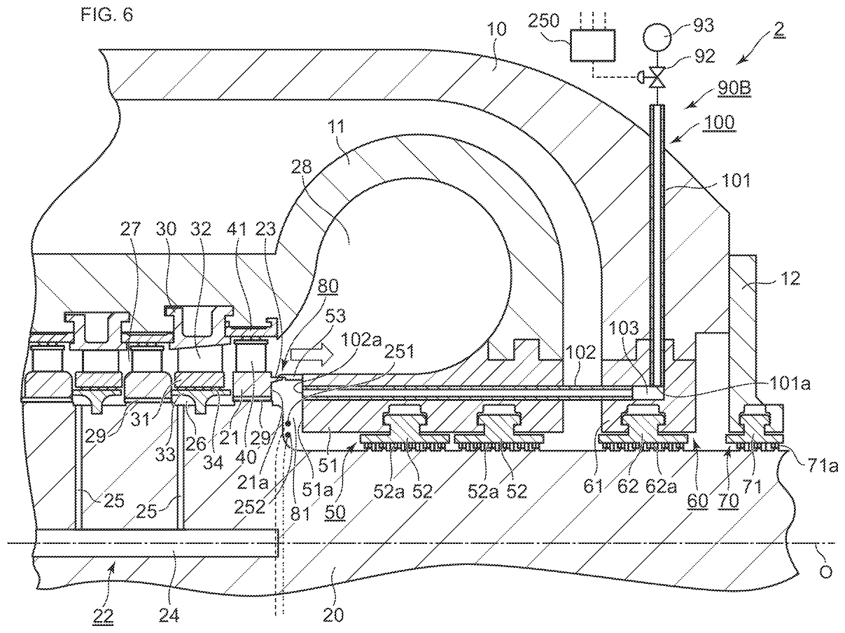

FIG. 6 is a view illustrating a meridian cross section of an axial flow turbine 2 of a second embodiment. Note that FIG. 6 illustrates a turbine structure of a gas turbine. Incidentally, in the following embodiment, the same constituent portions as those of the axial flow turbine 1 of the first embodiment are denoted by the same reference signs, and redundant explanations are omitted or simplified.

The axial flow turbine 2 of the second embodiment has the same configuration as that of the axial flow turbine 1 of the first embodiment except a configuration of a cooling medium supply mechanism. Therefore, the configuration of the cooling medium supply mechanism is mainly described here.

A cooling medium supply mechanism 90B supplies a cooling medium directly to a wheel space 81. The cooling medium supply mechanism 90B includes an introduction passage 100, a pressure regulating valve 92, and a cooling medium supply source 93, as illustrated in FIG. 6.

Further, the cooling medium supply mechanism 90B includes a control unit 250 and various sensing units (a temperature sensing unit 251, a pressure sensing unit 252, a load sensing unit 257) similarly to the first embodiment. Note that the sensing units include at least one of these sensing units.

The introduction passage 100 introduces the cooling medium from the cooling medium supply source 93 to the wheel space 81. The introduction passage 100 is constituted of introduction pipes 101, 102 and an introduction hole 103, for example.

As illustrated in FIG. 6, the introduction hole 103 is formed in a packing head 61 in the axial direction. The introduction hole 103 is a hole formed from a packing head 51 side toward the axial outside (the right side in the figure), for example. An end portion on the axial outside of the introduction hole 103 is closed.

The introduction pipe 101 is disposed through an outer casing 10 and the packing head 61 in the radial direction. Then, one end of the introduction pipe 101 is communicated with the introduction hole 103.

The introduction pipe 102 is provided to penetrate the packing head 51 along the axial direction. Further, one end of the introduction pipe 102 is coupled to the introduction hole 103. Then, the other end 102a of the introduction pipe 102 is open into the wheel space 81. The other end 102a of the introduction pipe 102 functions as an outlet of the introduction passage 100.

Incidentally, here, one example in which the passage formed in the radial direction and communicated with the introduction hole 103 is constituted by the introduction pipe 101 and the passage formed in the axial direction and communicated with the introduction hole 103 is constituted by the introduction pipe 102 is indicated, but this configuration is not restrictive.

For example, the radial passage formed in the outer casing 10 and the radial passage formed in the packing head 61 may be formed by introduction holes. Note that in this case, a communication portion between the outer casing 10 and the packing head 61 is constituted by an introduction pipe.

Further, the axial passage formed in the packing head 51 may be formed by an introduction hole. In this case, the communication between the packing head 51 and the packing head 61 is constituted by an introduction pipe.

Further, the introduction pipe which communicates the packing head 51 and the packing head 61 with each other may be constituted by a flexible pipe capable of expansion and contraction in the axial direction, or the like, for example. This makes it possible to, even when a thermal expansion difference occurs in an inner casing 11 and the outer casing 10 in the axial direction, absorb the thermal expansion difference.

Incidentally, the operation of the cooling medium supply mechanism 90B is the same as the operation of the cooling medium supply mechanism 90A.

According to the axial flow turbine 2 of the second embodiment, including the cooling medium supply mechanism 90B allows the cooling medium at an optimum pressure to be supplied directly into the wheel space 81 regardless of the load of the axial flow turbine 2. This enables accurate cooling of the turbine rotor 20, the gland seal part 50, and the like. Further, the combustion gas having passed through the final-stage rotor blade 40 can also be prevented from flowing into the wheel space 81.

### Third Embodiment

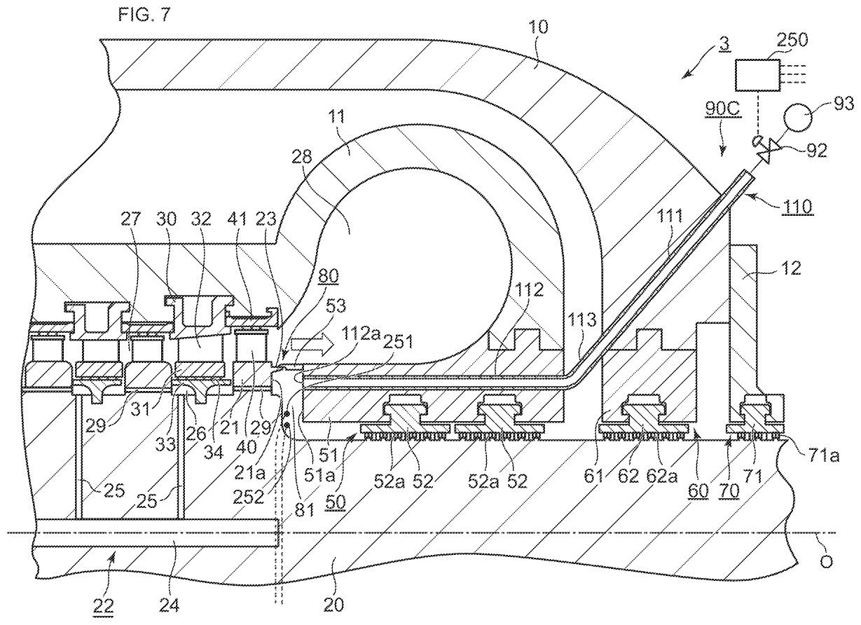

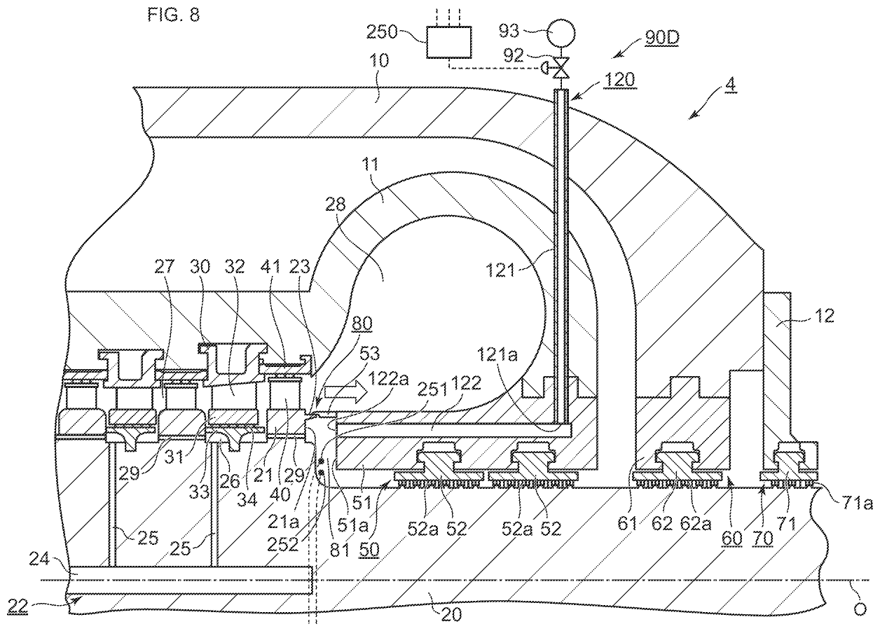

FIG. 7 is a view illustrating a meridian cross section of an axial flow turbine 3 of a third embodiment. Note that FIG. 7 illustrates a turbine structure of a gas turbine.

The axial flow turbine 3 of the third embodiment has the same configuration as that of the axial flow turbine 1 of the first embodiment except a configuration of a cooling medium supply mechanism. Therefore, the configuration of the cooling medium supply mechanism is mainly described here.

A cooling medium supply mechanism 90C supplies a cooling medium directly to a wheel space 81. The cooling medium supply mechanism 90C includes an introduction passage 110, a pressure regulating valve 92, and a cooling medium supply source 93, as illustrated in FIG. 7.

Further, the cooling medium supply mechanism 90C includes a control unit 250 and various sensing units (a temperature sensing unit 251, a pressure sensing unit 252, a load sensing unit 257) similarly to the first embodiment. Note that the sensing units include at least one of these sensing units.

The introduction passage 110 introduces the cooling medium from the cooling medium supply source 93 to the wheel space 81. The introduction passage 110 is constituted of introduction pipes 111, 112, 113, for example.

As illustrated in FIG. 7, the introduction pipe 111 is provided to penetrate an outer casing 10 in an oblique direction.

The introduction pipe 112 is provided to penetrate a packing head 51 along the axial direction. One end 112a of the introduction pipe 112 is open into the wheel space 81. The one end 112a of the introduction pipe 112 functions as an outlet of the introduction passage 110.

The introduction pipe 113 is provided between an inner casing 11 and the outer casing 10 and couples the introduction pipe 111 and the introduction pipe 112. The introduction pipe 113 may be constituted by a flexible pipe capable of expansion and contraction in the axial direction, or the like, for example. This makes it possible to, even when a thermal expansion difference occurs in the inner casing 11 and the outer casing 10 in the axial direction, absorb the thermal expansion difference.

Incidentally, here, one example in which the oblique passage formed in the outer casing 10 is constituted by the introduction pipe 111 and the axial passage formed in the packing head 51 is constituted by the introduction pipe 112 is indicated, but this configuration is not restrictive.

The oblique passage formed in the outer casing 10 may be constituted by an introduction hole. Further, the axial passage formed in the packing head 51 may be formed by an introduction hole.

Incidentally, the operation of the cooling medium supply mechanism 90C is the same as the operation of the cooling medium supply mechanism 90A.

According to the axial flow turbine 3 of the third embodiment, including the cooling medium supply mechanism 90C allows the cooling medium at an optimum pressure to be supplied directly into the wheel space 81 regardless of the load of the axial flow turbine 3. This enables accurate cooling of a turbine rotor 20, a gland seal part 50, and the like. Further, the combustion gas having passed through the final-stage rotor blade 40 can also be prevented from flowing into the wheel space 81.

### Fourth Embodiment

FIG. 8 is a view illustrating a meridian cross section of an axial flow turbine 4 of a fourth embodiment. Note that FIG. 8 illustrates a turbine structure of a gas turbine.

The axial flow turbine 4 of the fourth embodiment has the same configuration as that of the axial flow turbine 1 of the first embodiment except a configuration of a cooling medium supply mechanism. Therefore, the configuration of the cooling medium supply mechanism is mainly described here.

A cooling medium supply mechanism 90D supplies a cooling medium directly to a wheel space 81. The cooling medium supply mechanism 90D includes an introduction passage 120, a pressure regulating valve 92, and a cooling medium supply source 93, as illustrated in FIG. 8.

Further, the cooling medium supply mechanism 90D includes a control unit 250 and various sensing units (a temperature sensing unit 251, a pressure sensing unit 252, a load sensing unit 257) similarly to the first embodiment. Note that the sensing units include at least one of these sensing units.

The introduction passage 120 introduces the cooling medium from the cooling medium supply source 93 to the wheel space 81. The introduction passage 120 is constituted of an introduction pipe 121 and an introduction hole 122, for example.

As illustrated in FIG. 8, the introduction hole 122 is formed in a packing head 51 in the axial direction. The introduction hole 122 is a hole formed from the final-stage rotor wheel 21 side toward the axial outside (the right side in the figure), for example. An end portion on the axial outside of the introduction hole 122 is closed.

One end 122a of the introduction hole 122 is open into the wheel space 81. The one end 122a of the introduction hole 122 functions as an outlet of the introduction passage 120.

The introduction pipe 121 is disposed through an outer casing 10, an inner casing 11, and the packing head 51 in the radial direction. Then, one end of the introduction pipe 121 is communicated with the introduction hole 122.

Incidentally, here, one example in which the passage formed in the radial direction and communicated with the introduction hole 122 is constituted by the introduction pipe 121 is indicated, but this configuration is not restrictive.

For example, the radial passage formed in the outer casing 10, the radial passage formed in the inner casing 11, and the radial passage formed in the packing head 51 may be formed by introduction holes. Note that in this case, a communication portion between the outer casing 10 and the inner casing 11 and a communication portion between the inner casing 11 and the packing head 51 are constituted by introduction pipes.

In this case, the introduction pipe which communicates the outer casing 10 and the inner casing 11 with each other may be constituted by a flexible pipe capable of expansion and contraction in the axial direction and the radial direction, or the like, for example.

Here, the above-described introduction passage 120 has no piping configuration in the axial direction which is provided between the outer casing 10 and the packing head 51 and between the packing head 51 and the packing head 61, for example. Therefore, an influence of a thermal expansion difference in the axial direction between the inner casing 11 and the outer casing 10 is unlikely to be exerted.

Incidentally, the operation of the cooling medium supply mechanism 90D is the same as the operation of the cooling medium supply mechanism 90A.

According to the axial flow turbine 4 of the fourth embodiment, including the cooling medium supply mechanism 90D allows the cooling medium at an optimum pressure to be supplied directly into the wheel space 81 regardless of the load of the axial flow turbine 4. This enables accurate cooling of a turbine rotor 20, a gland seal part 50, and the like. Further, the combustion gas having passed through the final-stage rotor blade 40 can also be prevented from flowing into the wheel space 81.

### Fifth Embodiment

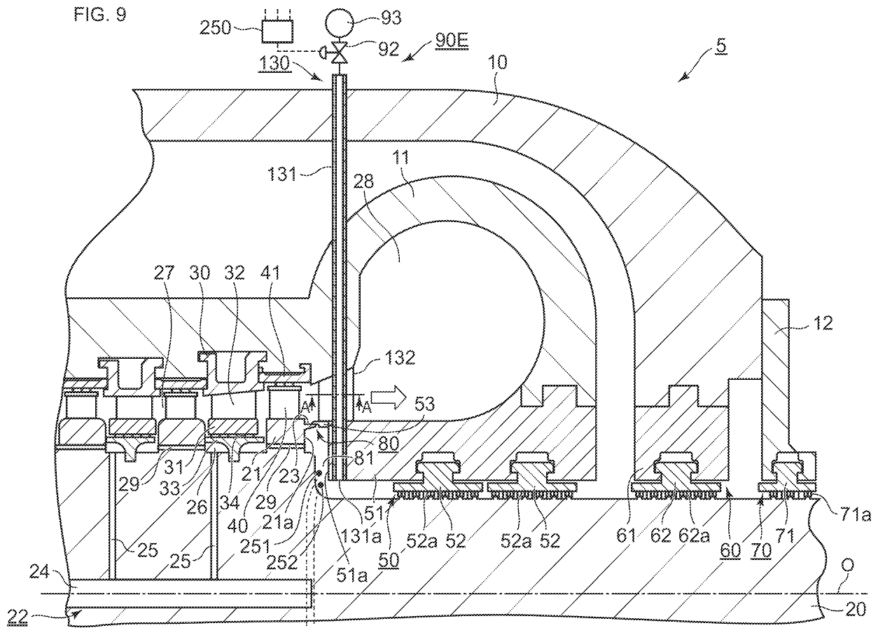

FIG. 9 is a view illustrating a meridian cross section of an axial flow turbine 5 of a fifth embodiment. Note that FIG. 9 illustrates a turbine structure of a gas turbine.

The axial flow turbine 5 of the fifth embodiment has the same configuration as that of the axial flow turbine 1 of the first embodiment except a configuration of a cooling medium supply mechanism. Therefore, the configuration of the cooling medium supply mechanism is mainly described here.

A cooling medium supply mechanism 90E supplies a cooling medium directly to a wheel space 81. The cooling medium supply mechanism 90E includes an introduction passage 130, a pressure regulating valve 92, and a cooling medium supply source 93, as illustrated in FIG. 9.

Further, the cooling medium supply mechanism 90E includes a control unit 250 and various sensing units (a temperature sensing unit 251, a pressure sensing unit 252, a load sensing unit 257) similarly to the first embodiment. Note that the sensing units include at least one of these sensing units.

The introduction passage 130 introduces the cooling medium from the cooling medium supply source 93 to the wheel space 81. The introduction passage 130 is constituted of an introduction pipe 131 and a strut 132, for example.

As illustrated in FIG. 9, the introduction pipe 131 is disposed through an outer casing 10, an inner casing 11, and a packing head 51 in the radial direction. The introduction pipe 131 is disposed to cross an inlet of an exhaust hood 28 in the radial direction.

One end 131a of the introduction pipe 131 is open into the wheel space 81. The one end 131a of the introduction pipe 131 functions as an outlet of the introduction passage 130.

The strut 132 is constituted by a hollow columnar body and covers the introduction pipe 131 at a portion crossing the exhaust hood 28. The strut 132 is provided over between the inner casing 11 and the packing head 51 at the inlet of the exhaust hood 28 as illustrated in FIG. 9.

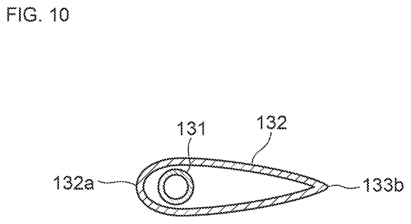

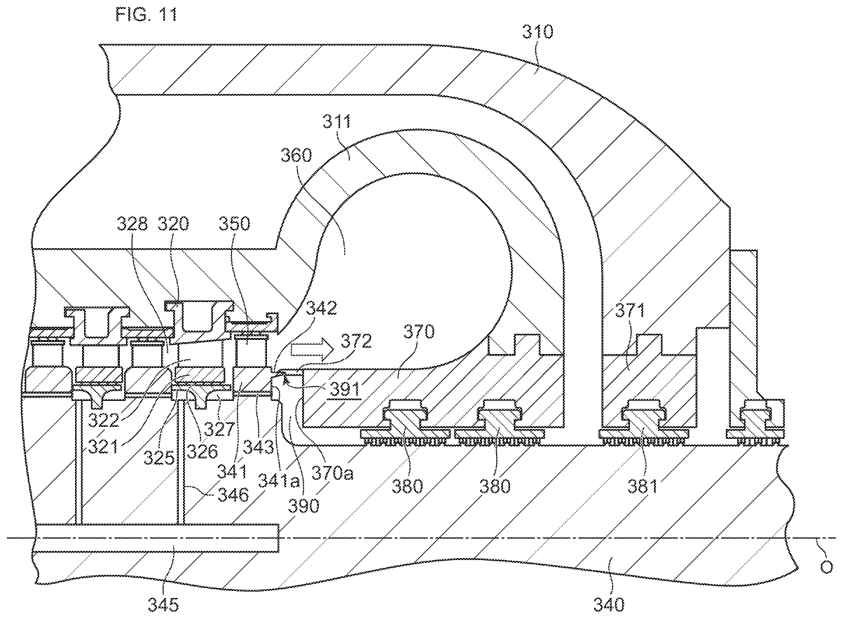

FIG. 10 is a view illustrating an A-A cross section of FIG. 9.

The strut 132 has an airfoil shape, as illustrated in FIG. 10, for example. In the strut 132, a leading edge 132a is disposed on an upstream side and a trailing edge 132b is disposed on a downstream side. A size of the strut 132 is preferably as small as possible in order to reduce a pressure loss caused by including the strut 132. Further, in a case of including the strut 132, setting a shape of the strut 132 in the airfoil shape enables suppression of the pressure loss at the inlet of the exhaust hood 28.

Incidentally, here, one example of including the strut 132 for protecting the introduction pipe 131 which is directly exposed to a combustion gas is indicated, but a configuration of not including the strut 132 is applicable. In this case, there is set a configuration in which the introduction pipe 131 is disposed to be exposed in a manner to cross the inlet of the exhaust hood 28 in the radial direction.

Incidentally, here, one example in which the passage formed in the radial direction is constituted by the introduction pipe 131 is indicated, but this configuration is not restrictive.

For example, the radial passage formed in the outer casing 10, the radial passage formed in the inner casing 11, and the radial passage formed in the packing head 51 may be formed by introduction holes. Note that in this case, a communication portion between the outer casing 10 and the inner casing 11 and a communication portion between the inner casing 11 and the packing head 51 are constituted by introduction pipes.

In this case, the introduction pipe which communicates the outer casing 10 and the inner casing 11 with each other may be constituted by a flexible pipe capable of expansion and contraction in the axial direction and the radial direction, or the like, for example.

Here, the above-described introduction passage 130 has no piping configuration in the axial direction which is provided between the outer casing 10 and the packing head 51 and between the packing head 51 and the packing head 61, for example. Therefore, an influence of a thermal expansion difference in the axial direction between the inner casing 11 and the outer casing 10 is unlikely to be exerted.

Incidentally, the operation of the cooling medium supply mechanism 90E is the same as the operation of the cooling medium supply mechanism 90A.

According to the axial flow turbine 5 of the fifth embodiment, including the cooling medium supply mechanism 90E allows the cooling medium at an optimum pressure to be supplied directly into the wheel space 81 regardless of the load of the axial flow turbine 5. This enables accurate cooling of a turbine rotor 20, a gland seal part 50, and the like. Further, the combustion gas having passed through the final-stage rotor blade 40 can also be prevented from flowing into the wheel space 81.

According to the embodiments described above, it becomes possible to supply the cooling medium at an optimum pressure to the wheel space on the downstream side of the final-stage turbine stage regardless of the load of the axial flow turbine.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An axial flow turbine, comprising:
a casing;
a turbine rotor provided to penetrate in the casing;
a rotor wheel which protrudes from an outer peripheral surface of the turbine rotor to a radial outside over a circumferential direction and is formed in a plurality of stages in a turbine rotor axial direction, the rotor wheel having rotor blades in the circumferential direction;
a first seal part provided on a downstream side of the rotor wheel at a final stage with a predetermined gap apart from the rotor wheel, the first seal part sealing between the turbine rotor and the casing;
a second seal part provided between the rotor wheel at the final stage and the first seal part, the second seal part preventing inflow to the turbine rotor side of a working fluid having passed through the rotor blade at the final stage; and
a cooling medium supply mechanism which supplies a cooling medium directly to a space surrounded by the rotor wheel at the final stage, the turbine rotor, the first seal part and the second seal part.

2. The axial flow turbine according to claim 1, wherein
the cooling medium supply mechanism comprises a pressure regulating valve which regulates a pressure of a cooling medium supplied to the space.

3. The axial flow turbine according to claim 1, wherein
the cooling medium supply mechanism comprises an introduction passage which introduces a cooling medium from an outside of the axial flow turbine to the space.

4. The axial flow turbine according to claim 3, wherein
the introduction passage is formed in the first seal part, or the first seal part and the casing.

5. The axial flow turbine according to claim 3, wherein
the introduction passage is constituted of an introduction pipe, or an introduction pipe and an introduction hole.

6. The axial flow turbine according to claim 4, wherein
the introduction passage is constituted of an introduction pipe, or an introduction pipe and an introduction hole.

7. The axial flow turbine according to claim 1, wherein
the second seal part comprises:
a first seal fin which protrudes from an upstream-side end face of the first seal part to an upstream side; and
a second seal fin whose tip portion is disposed to be displaced from a tip portion of the first seal fin in a radial direction and which protrudes from a downstream-side end face of the rotor wheel at the final stage to a downstream side.

8. The axial flow turbine according to claim 1, wherein
the casing comprises an outer casing and an inner casing disposed in the outer casing.

9. The axial flow turbine according to claim 1, wherein
the cooling medium supply mechanism supplies a cooling medium to the space or blocks supply of a cooling medium to the space based on a temperature or a pressure in the space, or a load of the axial flow turbine.
